(19) United States
(12) Patent Application Publication
(10) Pub. No.: US 2002/0065715 A1
(43) Pub. Date: May 30, 2002

(54) Integrated broadcasting and impulse purchasing system

(76) Inventors: Christopher Tennyson, Bloomfield Hills, MI (US); Jack R. Selecky, Sterling Heits, MI (US)

Correspondence Address: Harness, Dickey & Pierce, P.L.C., P.O. Box 828, Bloomfield Hills, MI, 48303, US

(21) Appl. No.: 09/726,976

(22) Filed: Nov. 30, 2000

(51) Int. Cl. G06F 17/60

(52) U.S. Cl. 705/14; 705/26; 705/27

(57) ABSTRACT

A method and marketing system for increasing impulse purchases of retail items through the integration of broadcast programming and retail sales to consumers over the Internet. The retail item that is featured in a mass media presentation is made available at a retail web site of a retailer. Visual indicium that identifies a conduit web site is added to a broadcast of the mass media presentation. A consumer is linked to the retail web site of the retailer using a category menu and links that are provided by the conduit web site. The visual indicium is displayed at a time when the retail item is visible in the mass media presentation. The retail item is made available at the retail web site before the visual mass media program is broadcast.

### FIELD OF THE INVENTION

This invention relates to distributed purchasing systems and more particularly to distributed purchasing systems that are integrated with mass media broadcasting systems.

### BACKGROUND OF THE INVENTION

There are many different broadcasting systems for providing mass media programming to televisions or other video displays that are located in the homes of consumers. Radio frequency (RF) mass media signals are conventionally broadcast via airwaves and are received by television antennas. Because of the reception problems and the relatively poor quality of the signal, cable systems were developed. Cable systems transmit mass media programming via coaxial and/or fiber-optic cables that directly connect the media provider to the consumer. Cable systems significantly improved the signal quality and eliminated the reception problems that were associated with RF-based broadcasting systems.

The cable consumer typically receives all of the local channels that were previously received in the RF-based broadcasting systems plus additional cable channels. The consumer is charged a base monthly fee for a basic set of cable channels. Typically, the cable systems include a set top box that receives the signal from the cable provider and provides channel tuning via a remote control or keypad. The set top box may also provide other services such as pay-per-view programming, video games, and access to the Internet. For example, WebTV® integrates both cable programming and Internet access. Analog and digital satellite-based systems also provide both local and other cable channels and pay-per-view services. The satellite systems require satellite dishes that receive the RF signals from the orbiting satellites.

There are several web sites that currently provide mass media programming via the Internet on a limited basis. Web sites such as www.cnn.com provide audio and video clips using streaming audio and video techniques. Advantages of these web-based systems include the ability to integrate Internet-type services with mass media programming, to provide a wider variety of programs, and to reach a wider audience with limited startup costs. Current disadvantages include insufficient bandwidth for carrying real-time video to a wide audience. Most consumers do not have a sufficiently high connection speed to feasibly use streaming video. When the bandwidth of the Internet improves, the Internet will become an additional system for pervasive mass media broadcasting.

Retailers pay for commercials on mass media programs because they are an effective way to create awareness of the retailer and to communicate information about its retail products to consumers. Retailers carefully select the mass media programs for placement of commercials. Retailers select mass media programs for commercial advertisements if the audience of the program has the correct demographic profile.

One significant disadvantage of the commercials is the inability of consumers to immediately purchase the retail product. The majority of television programs are viewed from the consumer's home, therefore the consumer must leave home to purchase the retail product. By failing to provide an immediate purchase opportunity, the effectiveness of the commercial is dramatically reduced because the likelihood that the consumer will purchase the retail product diminishes over time as the consumer forgets about the commercial.

Infomercials are television programs that are an extended advertisement that often include discussion of the product's attributes and demonstrations. Infomercials attempt to capitalize on the consumer's impulse to purchase the retail product by providing an opportunity to purchase the retail product while the consumer is viewing the infomercial. Infomercials are one of the most effective forms of mass media marketing. Infomercials feature a product in a program segment and typically display a toll-free number as often as possible to allow consumers to purchase the retail product. To increase the chances of an impulse purchase, the infomercials limit the amount of a time within which the consumer may purchase the retail product at the advertised price.

Infomercials attempt to capitalize on the consumer's impulse to purchase the retail product before the consumer forgets about it. Unfortunately, however, the infomercials do not appeal to a wide audience. The infomercials are also very expensive because the retailer must purchase the entire time for the program segment. Consumers tend to turn the infomercial off because of its relatively low entertainment value.

Another approach for advertising a retail product is to provide the retail product, such as clothing, to an actor who performs in a mass media program such as a movie, a music video or a TV show. The actor wears the retail product during the program. The retailer purchases commercial time and advertises the same retail product. The commercial identifies the retail product in the program and the retailer. Alternately, during the credits for the mass media program, an announcer and/or a textual message identifies the retail product and the retailer.

The disadvantage with this approach is that the consumer generally cannot satisfy their impulse to purchase immediately. The consumer must find a local retail store, travel to the retail store, and find and purchase the retail product. The consumer may lose interest or forget about the retail product before they have an opportunity to visit the local retail store. Alternately, the retailer may not have a local retail store and/or the retail store may not have the advertised retail product in inventory.

Advances in multimedia, communication and networking technologies have dramatically increased the use of electronic commerce. In particular, businesses have developed web sites that provide an electronic storefront to encourage consumers to view their merchandise from remote locations and to purchase their merchandise. Consumers use various types of devices to access the Internet such as computers, personal digital assistants, web-enabled cellular phones or other Internet-enabled devices.

Advantages of electronic storefronts include reduced overhead costs due to the lack of investment in brick and mortar. Electronic commerce also provides businesses with significant gains in efficiency through better management of inventory. In other words, the volume and number of transaction increases, which makes inventory management easier than brick and mortar facilities having lower volume. In addition, consumers can access the electronic storefront from any location in the world that provides access to the Internet. Electronic commerce also has the capability of reaching a wider audience than individual brick and mortar storefronts with relatively low initial capital costs.

While many businesses have retail web sites on the Internet, the Internet does not encourage impulse purchasing. Oftentimes, the consumer needs to spend a significant amount of time finding the web site of the retailer. Additional time must be spent by the consumer finding products in the web site. If the consumer is not already familiar with the retailer's products, the pictures that are provided by the web site are often not sufficient enough to encourage the consumer to purchase the retail product. Consumers tend to want to see more of the retail product before making a purchase.

### SUMMARY OF THE INVENTION

The present invention discloses a method for increasing impulse purchases of retail items through the integration of broadcast programming and retail sales to consumers over a distributed communications system. A retail item is featured in a mass media presentation. The featured retail item is made available at a retail web site of a retailer. Visual indicium is added to a broadcast of the mass media presentation. The visual indicium identifies a conduit web site. A consumer is linked to the retail web site of the retailer of the featured retail item using menus and links that are provided by the conduit web site.

In other features of the invention, a conduit server hosts the conduit web site. The conduit web site is organized using category menus that contain links that help the consumer find the featured retail item from an electronic catalog of featured retail items. The category menus include at least one of a movie category, a television program category, a music video category, and a performer name category.

In still other features of the invention, the visual indicium is displayed at a time when the retail item is visible in the mass media presentation. The retail item is made available at the retail web site before the visual mass media program is broadcast. A media producer and a performer are compensated based on sales of the retail item. The mass media presentation is optionally recorded while the consumer investigates the retail product at the conduit web site using a television service such as TiVo™.

A marketing system for increasing impulse purchases of retail items includes a distributed communications system. A retail server hosts a retail web site for a retailer. The retail server is connected to the distributed communications system. The retailer offers a retail item at the retail web site. A conduit server hosts a conduit web site and is connected to the distributed communications system. The conduit web site includes a category menu with links. A receiver receives and displays the visual mass media presentation that features the retail item and that includes visual indicium that identifies the conduit web site.

In other features of the invention, the category menu includes at least one of a movie category, a television category, a music video category, a retailer category, and a performer name category. The visual indicium is displayed when the retail item is visible in the mass media presentation. The retail item is preferably made available at the retail web site before the mass media presentation is broadcast. A media producer and a performer are compensated based on sales of the retail item. A recorder that is connected to the receiver optionally records the mass media presentation while the consumer visits the conduit web site during the mass media presentation.

Still other aspects, objects, features and advantages will be apparent to skilled artisans upon reviewing the specification, the drawings and the claims that follow.

### BRIEF DESCRIPTION OF THE DRAWINGS

The various features and advantages of the present invention will become apparent to one skilled in the art upon reading the following specification and by reference to the drawings in which:

FIG. 1A is a functional block diagram illustrating an integrated broadcasting and impulse purchasing system according to the present invention;

FIG. 1B illustrates a television or other display for viewing a mass media presentation that includes indicium according to the present invention;

FIG. 2 illustrates a digital recorder for recording mass media presentations;

FIG. 3 is a functional block diagram illustrating an alternate integrated mass media broadcasting and Internet impulse purchasing system according to the present invention;

FIG. 4, illustrates steps for providing the integrated broadcasting and impulse purchasing system; and

FIG. 5 illustrates a browser and a conduit web site.

### DETAILED DESCRIPTION OF THE PREFERRED EMBODIMENTS

The ensuing detailed description provides preferred exemplary embodiments only and is not intended to limit the scope, applicability or configuration of the present invention. Rather, the ensuing detailed description of the preferred exemplary embodiments will provide those skilled in the art with an enabling description for implementing the preferred exemplary embodiments of the present invention. It being understood that various changes may be made in the function and arrangement of the elements without departing from the spirit and scope of the invention as set forth in the appended claims.

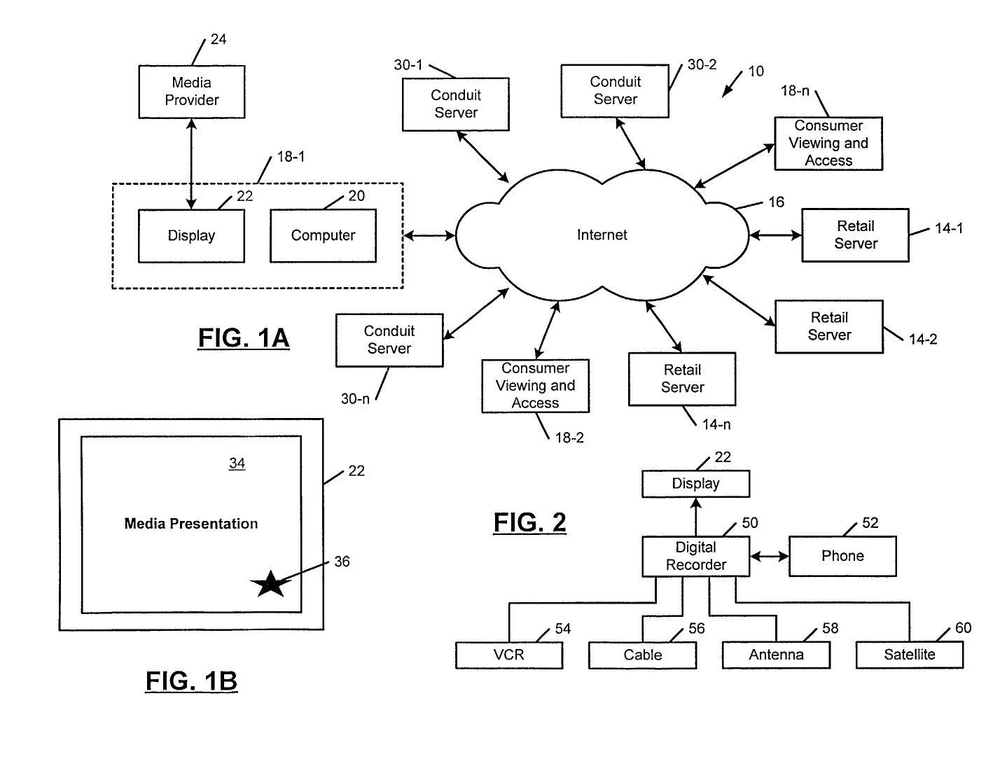

Referring now to FIG. 1, an integrated broadcasting and impulse purchasing system is shown and is generally designated 10. The integrated broadcasting and impulse purchasing system 10 includes one or more retail servers 14-1, 14-2, . . . , 14-n that are connected to a distributed communications system 16. The retail servers 14 host retail web sites that offer retail products such as goods and/or services for sale to consumers through the distributed communications system 16. The distributed communications system 16 is preferably a public network such as the Internet. The distributed communications system 16 can also be a private network, an extranet and/or a private network that is connected to a public network such as the Internet through a gateway (such as set top box systems).

Consumer access points 18-1, 18-2, . . . , 18-n include a computer 20 that is accessible by the consumer and a display 22 that is likewise accessible by the consumer. The computer 20 includes a processor, a keyboard, a mouse, a display and/or other input/output devices (all not shown). The computer 20 and the display 22 can also be located in a relatively close proximity. For example, the computer 20 and the display 22 can be located in the home of the consumer. The computer 20 and the display 22 can also be located remotely. For example, the display 22 can be located in the consumers home and a computer 20 can be located at the workplace on the consumer. The display 22 is preferably a television, a peripheral display that is capable of playing video or video and audio, or any other type of display. Alternately, the display of the computer 20 and the display 22 can be integrated. For example, the computer 20 can have a television or cable tuner and/or the Internet can be used for transmitting and receiving the broadcast (as will be described further below).

A media provider 24 transmits mass media presentation or broadcasts such as television programs, music videos, movies, sporting events, etc. to the display 20. The mass media presentations are preferably predominantly non-promotional (in contrast, infomercials are predominantly promotional) so that a wider audience is reached. The mass media broadcasts may be provided by a radio frequency (RF) signal, a cable signal provided by a coaxial or fiber-optic connection, a satellite connection, a phone connection, and/or through the distributed communications system 16 (as will be detailed further below).

The computer 20 can be a personal computer (such as notebooks or desktops), a personal digital assistant, a cellular phone, or other devices containing a display, a processor and memory. The computers 20 are connected to the distributed communications system 16 using phone lines, cable (coaxial or optical), radio frequency (RF), satellite or any other suitable method. One or more conduit servers 30-1, 30-2, . . . , 30-n are connected to the distributed communications system. The conduit servers 30 host a conduit web site.

Referring now to FIG. 1B, the display 22 is illustrated in further detail. The display 22 receives a mass media broadcast signal from the media provider 24. The mass media broadcast signal contains audio and video content in the form of a media presentation 34. During the media presentation 34, the mass media broadcast signal also contains indicium 36. The indicium 36 notifies the consumer that one or more retail products that are featured in the media presentation are available for purchase. The indicium 36 directs the consumer to the web site that is hosted by the conduit server 30. The web site that is hosted by the conduit server 30 contains links to retail servers 14 that, in turn, offer the retail product that is featured in the media presentation.

In a preferred embodiment, the indicium 36 is a well-known trademark symbol, a web site address, a logo, and/or a company name. The indicium 36 can also be a textual line that is displayed on the display 22 (such as along a bottom portion of the display 22) and that identifies the conduit web site address. If the web site address is not explicitly set forth, advertising will be used to associate the indicium 36 to the web site address of the conduit web site. For example a stylized star symbol may be used to direct consumers to www.starstyledirect.com. When media presentations display the indicium 36, consumers are notified that the retail products that are featured in the media presentation are available for purchase immediately by logging onto the conduit web site 30. By providing a single source (the conduit web site) for accessing products from one or more retail providers, there is a higher probability that consumers will not be confused and will reach the proper retailer before losing the impulse to purchase the retail product.

The conduit web site preferably provides menus that are arranged by product, by the type of the media presentation, by the name of the retailer, by the name of the performer and/or by the type of retail product to facilitate easy access. The menus allow consumers to locate a particular featured product from the remaining products from the same or other presentations. Using the menus, the conduit web site provides consumers with an easy way to locate the retail product and provides links to the retail web sites of the retailer that produces the featured retail product. For example, if the consumer saw the indicium on a music video, the consumer goes to the conduit web site and clicks on the music video link. A subsequent linked web page is arranged by artist name and/or music genre. The consumer selects music genre and a subsequent linked page lists rock, classical, folk, etc. The consumer selects rock, and a subsequent linked page lists artist names. The consumer selects the artist's name, and a subsequent link lists music videos for the artist. The consumer selects one of the music videos, and a subsequent linked page lists retail products with textual descriptions, photos, audio clips and/or video clips. A shopping cart may also be provided. One-click purchasing may also be employed as is disclosed in U.S. Pat. No. 5,960,411 to Hartman et al., which is hereby incorporated by reference. Once selected, the consumer purchases the item using standard credit card transaction protocols or any other suitable methods.

In an alternate embodiment, the conduit web site includes category menus that allow selection of the retail product. Purchase is completed using a single click from the conduit site.

In the preferred embodiment, the link provided by the conduit web site directly accesses a web page that relates to the specific retail product that was selected by the consumer without going through the retailer's home web page. The conduit web site and/or the retail web site tracks the sales of the retail product and compensates the conduit web site host, the media provider, the media producer and/or the star according to sales volume or other criteria.

In use, the media provider 24 provides a signal containing a media presentation. One or more retail products such as goods and services are featured in the media presentation. During the media presentation and/or immediately preceding or following the media presentation, the broadcast signal containing the media presentation displays indicium 36 to notify the consumer that the retail products featured in the media presentation are available for immediate purchase. Upon seeing indicium 36, the consumer uses the computer 20 to access the conduit web site hosted by the conduit server 30. The menus that are provided by the conduit web site assist the consumer in identifying the retail product from the media presentation and provide a link to the retail web site that is hosted by the retail server 14.

Referring now to FIG. 2, the display 22 is optionally connected to a digital video recorder 50 that records preset programs and allows the consumer to pause, rewind and record live programs. The digital video recorder 50 is optionally connected to a phone line 52. The digital recorder 50 is optionally connected to a VCR 54, cable system 56, antenna 58 and/or satellite 60. For example, the display 22 can be associated with a TV service such as TiVo™. The phone line 52 provides customized television program recording services. When the consumer decides to investigate featured products, the recorder 50 can be used to pause or record the presentation while the consumer purchases the featured product.

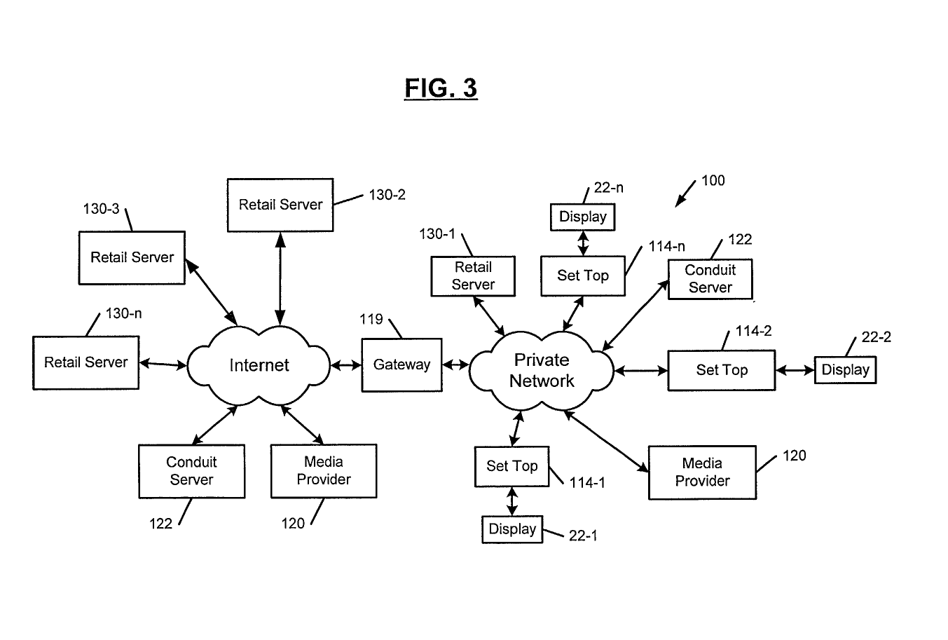

Referring now to FIG. 3, an alternate integrated broadcasting and impulse purchasing system 100 is illustrated. The integrated broadcasting and impulse purchasing system 100 operates in a manner that is analogous to the system 10 illustrated above. The display 22, however, is connected to a set top box 114 that is connected to a distributed communications system such as a private network 116. The set top box is controlled using a remote control and/or a key pad (both not shown). A media provider 120 is connected to the private network 116. A conduit server 122 is connected to the private network 116 and/or the Internet 124. The private network 116 is connected through a gateway 120 to the Internet 124. Retail servers 130 can be connected to the Internet 124 and/or the private network 116.

The integrated broadcasting and impulse purchasing system 100 can have several distinct modes of operation. In a first mode, the set top box 14 provides a first window for the media presentation and a second window for accessing the Internet. Some set top box systems can handle multiple simultaneous windows while others can handle only one window at a time. The indicium 36 in the first window that is associated with the media presentation does not operate as an Internet link. When the consumer sees the indicium and the retail products that he or she is interested in, the consumer minimizes or closes the first window that is associated with the media presentation 34. Then, the consumer uses the second window to access the conduit web site.

In a second mode of operation, the set top box allows Internet links to be superimposed over a media presentation. When a consumer sees retail products that he or she is interested in, the consumer clicks on the indicium that operates as a link. The consumer is immediately connected to the conduit web site where the consumer can access the menus provided by the conduit web site. In a third mode of operation, the private network 116 and the Internet 124 are integrated. The media provider 120 and the other devices connected to the private network and 116 are connected through the Internet 124. The media provider 120 provides the media presentation that includes the indicium 36 that is also an Internet link. The consumer clicks on the link and is immediately connected to the conduit web site. Optionally, the converged system can automatically pause or record the presentation.

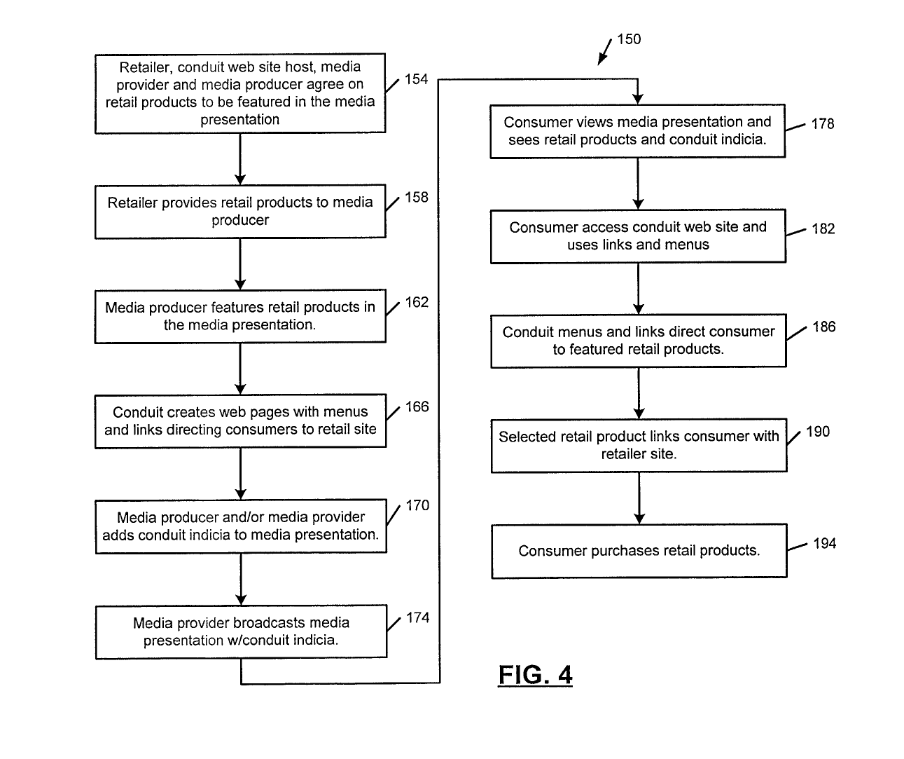

Referring now to FIG. 4, a method for providing an integrated broadcasting and impulse purchasing system is shown and is generally designated 150. In step 154, the retailer, the host of the conduit web site, the media provider and the media producer agree on retail products that are to be featured in the media presentation 34. In step 158, the retailer provides the retail products that are to be featured in the media presentation 34 to the media producer. In step 162, the media producer produces the media presentation 34 and features the retail products in the media presentation 34. For example, the media producer features furniture and other fixtures in the sets of a movie, TV show or music video. Alternately, the media producer features clothing from the retailer in the media presentation 34 by having actors wear the clothing. In step 166, the host of the conduit web site creates web pages with menus and links that direct consumers to the featured retail product and to the retailer of the featured retail product. In step 170, the media producer and/or the media provider adds the conduit indicium 36 to the media presentation 34. In step 174, the media provider broadcasts the media presentation with the conduit indicium 36. In step 178, the consumer watches the media presentation and sees the conduit indicium 36 and the retail products. In step 182, the consumer accesses the conduit web site that is identified by the indicium 36 and uses menus provided by the conduit web site to locate the retail products that the consumer is interested in. In step 186, the conduit web site directs the consumer to the desired retail product and, when selected, links the consumer to the retailer. In step 190, the Internet links connect the consumer to the retailer web site. In step 194, the consumer decides whether to purchase the retail products that are offered for sale on the retailer web site.

An alternate source of revenue for the operators of the conduit web site is generated by having the retailer pay the conduit web site for visits to their retail web sites. The host of the conduit web site is compensated for each visit to the retail web site that originates from the conduit web site. In other words, the conduit web site or the retail web site tracks the click stream for payment purposes.

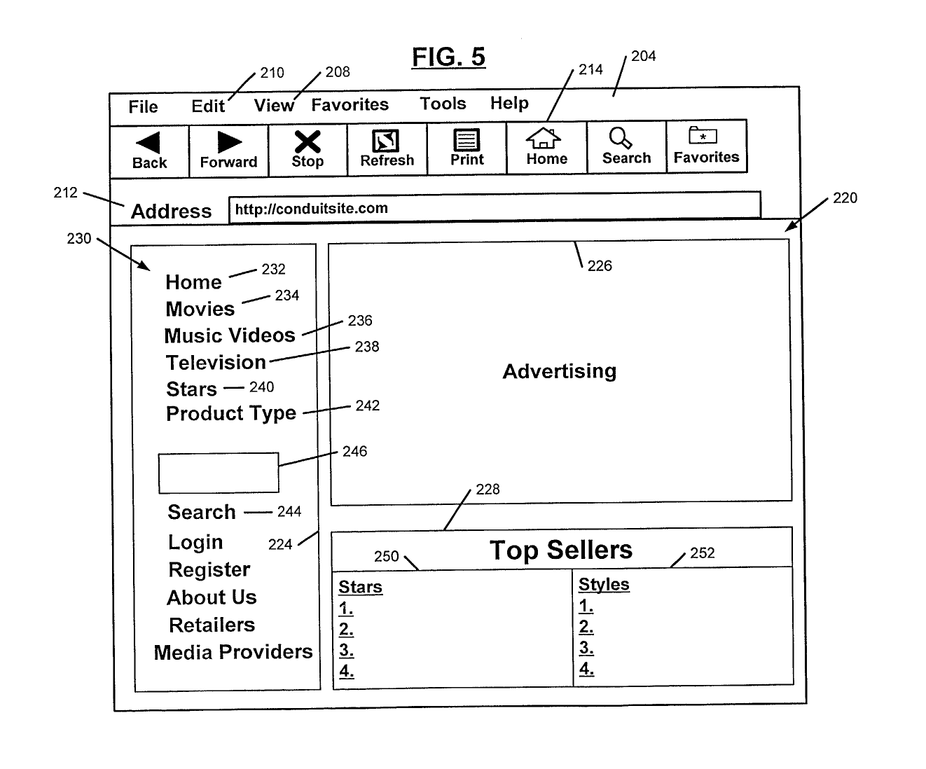

Referring now to FIG. 5, a browser 204 of the computer 20 is illustrated. The browser 204 includes a menu bar 208 that includes one or more drop-down menus 210, an address bar 212, and one or more command buttons 214 that provide conventional functions such as forward, back, home, search, favorites, etc. The consumer enters the web site address of the conduit web site 200 in the address bar 212 and presses the enter key. Alternately, if mass media broadcasting and the Internet coverage, this step can be automatically performed when the consumer clicks on the indicium 36. The conduit web site provides a home page 220 that is sent to the browser 204. The home page 220 includes one or more frames 224, 226 and 228. The frame 224 includes a menu 230 of links 232, 234, 236, 238, 240 and 242 that can be associated with a home page, a movies page, a music videos page, a TV program page, a star page, and a product locator page, respectively. Each of these pages contains additional links. For example, the movies page contains links to movies. The movie links that can be arranged and sorted by release year, title, stars, and/or distributor. Once the movie name is selected, the actor names and the retail products are listed. The frame 224 also preferably contains a search submit link 244 and a search text 246 box for searching the conduit web site.

The frame 226 contains text, video, etc. that are used to further advertise retailers, stars, and/or retail products that are featured by the conduit web site. The frame 228 contains first and second frames 250 and 252 that can be navigated using links and/or scroll bars. The frame 250 contains a list of stars who have been sold the most retail products via the conduit web site. The frame 252 contains retailers that have sold the most retail products via the conduit web site.

Those skilled in the art can now appreciate from the foregoing description that the broad teachings of the present invention can be implemented in a variety of forms. Therefore, while this invention has been described in connection with particular examples, thereof, the true scope of the invention should not be so limited since other modifications will become apparent to the skilled practitioner upon a study of the drawings, the specification and the following claims.

What is claimed is:

1. A method for increasing impulse purchases of retail items through the integration of broadcast programming and retail sales to consumers over a distributed communications system, comprising the steps of:
featuring a retail item in a mass media presentation;
making said retail item available at a retail web site of a retailer;
adding visual indicium to a broadcast of said mass media presentation, wherein said visual indicium identifies a conduit web site; and
linking a consumer to said retail web site of said retailer using links that are provided by said conduit web site.

2. The method of claim 1 wherein a conduit server hosts said conduit web site.

3. The method of claim 1 further comprising the step of:
organizing said conduit web site using category menu containing links that help said consumer find retail item.

4. The method of claim 3 wherein said category menus include movies, television programs, music videos, and performer names.

5. The method of claim 3 wherein said retail web site is accessed using said category menu.

6. The method of claim 1 further comprising the step of:
displaying said visual indicium at a time when said retail item is visible in said mass media presentation.

7. The method of claim 1 further comprising the step of:
making said retail item available at said retail web site before said visual mass media program is broadcast

8. The method of claim 1 further comprising the step of:
compensating a media producer of said mass media presentation based on sales of said retail item.

9. The method of claim 1 further comprising the step of:
compensating a performer in said mass media presentation based on sales retail item.

10. The method of claim 1 further comprising the step of:
automatically recording said mass media presentation while said consumer investigates said retail product at said conduit web site.

11. A marketing system for increasing impulse purchases of retail items, comprising:
a distributed communications system;
a retail server that hosts a retail web site for a retailer, wherein said retail server is connected to said distributed communications system and wherein said retailer offers a retail item;
a conduit server that hosts a conduit web site, that is connected to said distributed communications system and that includes links; and
a receiver for receiving and displaying a mass media presentation that features said retail item and that includes visual indicium that identifies said conduit web site.

12. The marketing system of claim 11 wherein said conduit web site includes a category menu for accessing said retail item.

13. The marketing system of claim 12 wherein said category menu includes at least one of a movie category, a television program category, a music video category, a retailer category and a performer name category.

14. The marketing system of claim 12 wherein said retail web site is accessed using said category menu.

15. The marketing system of claim 11 wherein said visual indicium is displayed when said retail item is visible in said mass media presentation.

16. The marketing system of claim 11 wherein said retail item is made available at said retail web site before said mass media presentation is broadcast.

17. The marketing system of claim 11 wherein a media producer of said mass media presentation is compensated based on sales of said retail item.

18. The marketing system of claim 11 wherein a performer in said mass media presentation is compensated based on sales of said retail item.

19. The marketing system of claim 11 further comprising:
a recorder that is connected to said receiver and that automatically records said mass media presentation when a consumer visits said conduit web site during said mass media presentation.
